(19) United States
(12) Patent Application Publication
(10) Pub. No.: US 2026/0168891 A1
(43) Pub. Date: Jun. 18, 2026

(54) TIRE WEAR MONITORING DEVICE AND TIRE WEAR MONITORING METHOD

(71) Applicant: BRIDGESTONE CORPORATION, Tokyo (JP)

(72) Inventor: Hiroyuki KATSUNO, Chuo-ku, Tokyo (JP)

(73) Assignee: BRIDGESTONE CORPORATION, Tokyo (JP)

(21) Appl. No.: 19/123,996

(22) PCT Filed: Nov. 21, 2023
(86) PCT No.: PCT/JP2023/041840

§ 371 Date: Apr. 24, 2025

(30) Foreign Application Priority Data
Dec. 26, 2022 (JP) 2022-208934

(51) Int. Cl. G01M 17/02; G06T 7/00; G06T 7/50

(52) U.S. Cl. CPC G01M 17/027; G06T 7/0002; G06T 7/50

(57) ABSTRACT

A tire wear monitoring device according to the present disclosure acquires an image obtained by imaging a tread portion of a tire, quantifies a degree of wear of the tread portion appearing in the image, determines whether the degree of wear is outside of an allowable range of durability of the tire, and outputs wear information for the tire in a case in which the degree of wear is determined to be outside of the allowable range.

### TECHNICAL FIELD

The present disclosure relates to a tire wear monitoring device and a tire wear monitoring method.

### BACKGROUND

Technology for monitoring the degree of wear of a tire is known. For example, Patent Literature (PTL) 1 discloses a method for detecting wear in the tread portion of a tire by providing a wear indicator in a groove of the tire tread.

### CITATION LIST

### Patent Literature

PTL 1: JP 2015-063652 A

### SUMMARY

### Technical Problem

However, demand exists for further improvement in the usefulness of technology for monitoring the degree of wear of a tire. For example, if a mining vehicle used at a mine site suddenly experiences tire failure, it becomes necessary to transport the mining vehicle and perform work such as changing the tire, which results in decreased productivity. In addition, it is costly to have workers inspect tires to prevent sudden failure. Therefore, there is a need to automate the monitoring of the degree of wear of a tire.

It is an aim of the present disclosure, conceived in view of such circumstances, to provide a tire wear monitoring device and a tire wear monitoring method that improve the usefulness of technology for monitoring the degree of wear of a tire.

### Solution to Problem

[1] A tire wear monitoring device according to an embodiment of the present disclosure includes a controller configured to acquire an image obtained by imaging a tread portion of a tire, quantify a degree of wear of the tread portion appearing in the image, determine whether the degree of wear is outside of an allowable range of durability of the tire, and output wear information for the tire in a case in which the degree of wear is determined to be outside of the allowable range.
[2] A tire wear monitoring device according to an embodiment of the present disclosure is the tire wear monitoring device of [1], wherein quantifying of the degree of wear preferably includes estimating a depth of a predetermined groove in the tread portion from at least one of a width and a length of the predetermined groove appearing in the image.
[3] A tire wear monitoring device according to an embodiment of the present disclosure is the tire wear monitoring device of [2], wherein the width of the predetermined groove preferably varies stepwise according to the depth of the predetermined groove, and the controller is preferably further configured to estimate the depth of the predetermined groove from the width of the predetermined groove using correspondence information between the depth and the width of the predetermined groove.
[4] A tire wear monitoring device according to an embodiment of the present disclosure is the tire wear monitoring device of [2], wherein the depth of the predetermined groove preferably varies stepwise along a length direction of the predetermined groove, and the controller is preferably further configured to estimate the depth of the predetermined groove from the length of the predetermined groove using correspondence information between the depth and the length of the predetermined groove.
[5] A tire wear monitoring device according to an embodiment of the present disclosure is the tire wear monitoring device of any one of [2] to [4], wherein as the predetermined groove, the tire preferably includes a first groove provided on one side and a second groove provided on another side of the tread portion in a tire width direction, with an equatorial plane of the tire as a boundary therebetween, and quantifying of the degree of wear preferably includes calculating a difference between a depth of the first groove and a depth of the second groove.
[6] A tire wear monitoring device according to an embodiment of the present disclosure is the tire wear monitoring device of any one of [1] to [5], wherein the controller is preferably further configured to acquire a travel distance or a travel time of a vehicle on which the tire is mounted, and determine whether the degree of wear is outside of the allowable range of durability of the tire based on the degree of wear and on the travel distance or the travel time of the vehicle.
[7] A tire wear monitoring device according to an embodiment of the present disclosure is the tire wear monitoring device of any one of [1] to [5], wherein the controller is preferably further configured to acquire a thermal history of the tire, and determine whether the degree of wear is outside of the allowable range of durability of the tire based on the degree of wear and the thermal history of the tire.
[8] A tire wear monitoring method according to an embodiment of the present disclosure is a tire wear monitoring method to be executed by one or more computers, the method including acquiring an image obtained by imaging a tread portion of a tire, quantifying a degree of wear of the tread portion appearing in the image, determining whether the degree of wear is outside of an allowable range of durability of the tire, and outputting wear information for the tire in a case in which the degree of wear is determined to be outside of the allowable range.

### Advantageous Effect

According to the present disclosure, a tire wear monitoring device and a tire wear monitoring method that can improve the usefulness of technology for monitoring the degree of wear of a tire can be provided.

### BRIEF DESCRIPTION OF THE DRAWINGS

In the accompanying drawings:

FIG. 1 is a diagram illustrating a schematic configuration of a tire wear monitoring system according to an embodiment of the present disclosure;

FIG. 2 is a block diagram illustrating a configuration of a server illustrated in FIG. 1;

FIG. 3 is a flowchart illustrating operations of the tire wear monitoring system illustrated in FIG. 1;

FIG. 4 is a diagram illustrating an example of an image of a tire;

FIG. 5 is a diagram illustrating an example of an outer surface of the tread portion of a tire;

FIG. 6 is a cross-sectional view illustrating a cross-section along line A-A′ in FIG. 5; and

FIG. 7 is a cross-sectional view illustrating a cross-section along line B-B′ in FIG. 5.

### DETAILED DESCRIPTION

A tire wear monitoring system according to an embodiment of the present disclosure is described below with reference to the drawings. Members and components that are common across drawings are labeled with the same reference signs. It should be noted that the drawings are schematic, and that the ratios of dimensions and the like may be different from the actual ones.

### (Configuration of Tire Wear Monitoring System)

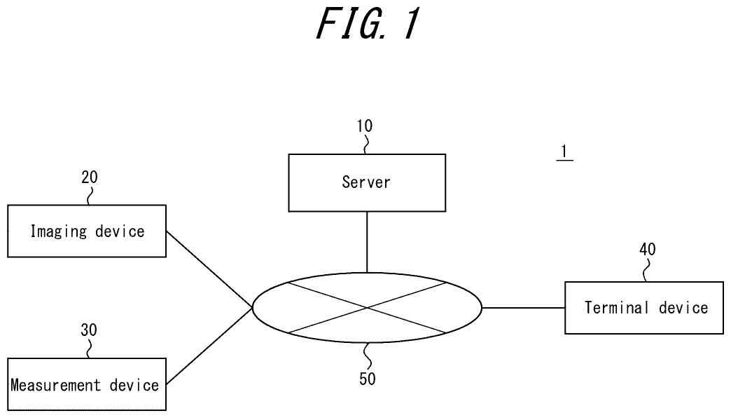

First, with reference to FIG. 1, an overview of tire wear monitoring system 1 according to the present embodiment is provided. FIG. 1 is a diagram illustrating a schematic configuration of the tire wear monitoring system 1. As illustrated in FIG. 1, the tire wear monitoring system 1 includes a server 10, an imaging device 20, a measurement device 30, and a terminal device 40. In FIG. 1, one each of the server 10, imaging device 20, measurement device 30, and terminal device 40 is illustrated. The tire wear monitoring system 1 may, however, include any number of servers 10, imaging devices 20, measurement devices 30, and terminal devices 40.

The server 10 is configured by one or more computers. In the present embodiment, the server 10 is described as being configured by one computer. The server 10 may, however, be configured by a plurality of computers, such as a cloud computing system. In the present disclosure, the server 10 is also referred to as a “tire wear monitoring device”.

The imaging device 20 is configured by a computer that includes at least one camera. The camera may be any camera capable of capturing images, such as a visible light camera, a thermographic camera, or an infrared camera. The image captured by the imaging device 20 may be a still image, such as a photograph, or may be a moving image. The imaging device 20 generates an image obtained by imaging the tire 2 and transmits the image to the server 10. At least a portion of the tire 2 appears in the image obtained by imaging the tire 2. In addition to at least a portion of the tire 2, at least a portion of a vehicle 3 on which the tire 2 is mounted may appear in the image obtained by imaging the tire 2.

The imaging device 20 may, for example, be a fixed imaging device 20 installed on the travel route of the vehicle 3 at the mine site. This enables the imaging device 20 to capture images of the vehicle 3 while it is traveling along the travel route, thereby avoiding a reduction in the utilization rate of the vehicle 3 and productivity at the mine. The imaging device 20 is not, however, limited to a fixed imaging device and may be an imaging device 20 mounted on a drone, or a movable imaging device such as a tablet device that can be carried by a human.

The measurement device 30 is configured by a computer that includes one or more sensors. The sensors may include, but are not limited to, a digital tachograph, a Tire Pressure Monitoring System (TPMS), an Electronic Control Unit (ECU), or a car navigation device.

For example, measurement data regarding the tire 2 mounted on the vehicle 3 includes tire condition data for the tire 2. The tire condition data may include the internal pressure (air pressure), inner cavity temperature, thermal history, or the like of the tire 2, but these examples are not limiting. The thermal history of the tire 2 is the history of heat applied to the tire 2 as a result of use of the tire 2. The thermal history of the tire 2 is used to evaluate how much energy has been applied to the tire 2 since the beginning of use of the tire 2. Generally, the greater the thermal history, the more deteriorated the tire 2 will be. The thermal history can, for example, be calculated by applying the inner cavity temperature of the tire 2 to the Arrhenius equation. The measurement data regarding the tire 2 mounted on the vehicle 3 also includes travel data for the vehicle 3. The travel data for the vehicle 3 may include the travel time, travel distance, speed, acceleration, or number of revolutions of the tire 2 for the vehicle 3, but these examples are not limiting. The measurement data regarding the tire 2 mounted on the vehicle 3 may be time series data including each measurement value, the corresponding measurement date and time, and the like.

The measurement device 30 measures the measurement data regarding the tire 2 mounted on the vehicle 3 and transmits the measurement data to the server 10. The measurement device 30 may therefore be installed on the vehicle 3 or the tire 2.

The terminal device 40 is, for example, a computer such as a smartphone, tablet device, or personal computer.

The network 50 is any communication network over which the server 10, the imaging device 20, the measurement device 30, and the terminal device 40 can communicate with each other. The network 50 in the present embodiment may, for example, be the Internet, a mobile communication network, a Local Area Network (LAN), or a combination thereof.

The tire wear monitoring system 1 is used to monitor the degree of wear of one or more tires 2. In the tire wear monitoring system 1, the server 10 acquires an image 60 obtained by imaging a tread portion 2A of the tire 2 from the imaging device 20, for example. The server 10 then quantifies the degree of wear of the tread portion 2A appearing in the image 60. The server 10 determines whether the degree of wear is outside of an allowable range of durability of the tire 2 and outputs wear information for the tire 2 in a case in which the degree of wear is determined to be outside of the allowable range.

For example, this wear information for the tire 2 may be transmitted from the server 10 to the terminal device 40 and displayed by the terminal device 40. In this way, according to the tire wear monitoring system 1, the server 10 can automatically monitor the degree of wear of the tread portion 2A of the tire 2 based on the image 60 acquired from the imaging device 20 and output wear information for the tire 2 according to the degree of wear.

In the present disclosure, the “degree of wear” of the tire 2 is an index representing the extent of wear that changes with use of the tire 2. In the present embodiment, the degree of wear of the tire 2 is represented by an index that increases with use of the tire 2. For example, the degree of wear of the tire 2 can be expressed as a number between 0 and 100, with the value in the initial state of the tire 2 being 0 and the value in the limit state of the tire 2 being 100. However, the degree of wear of the tire 2 may be expressed as an index that decreases with use of the tire 2.

In the present disclosure, the tire 2 is not particularly limited but may be an Off The Road (OR) tire, which is mounted on mining vehicles such as transport vehicles, construction vehicles, work vehicles, or heavy equipment vehicles used at mine sites and the like. The tire 2 may, however, be a tire other than an OR tire.

In the present disclosure, the vehicle 3 is, for example, a mining vehicle used at a mine site or the like. The vehicle 3 is not, however, limited to the above-described mining vehicle and may be any vehicle on which the tire 2 can be mounted, such as a transport vehicle, construction vehicle, work vehicle or heavy equipment vehicle, bus, passenger vehicle, motorcycle, bicycle, or airplane.

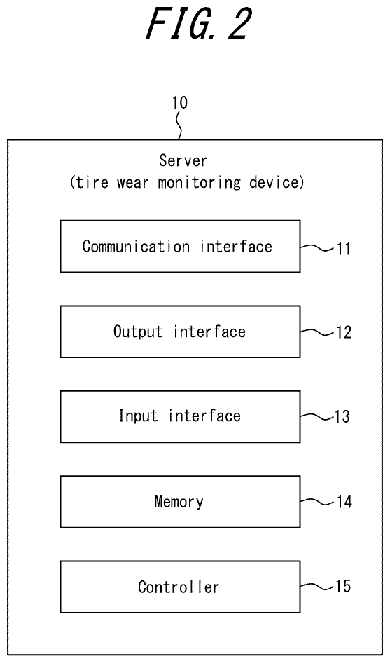

With reference to FIG. 2, the configuration of the server 10, i.e., the tire wear monitoring device, is now described in detail. FIG. 2 is a block diagram illustrating the configuration of the server 10. As illustrated in FIG. 2, the server 10 includes a communication interface 11, an output interface 12, an input interface 13, a memory 14, and a controller 15. In the server 10, the communication interface 11, the output interface 12, the input interface 13, the memory 14, and the controller 15 are communicably connected to each other in a wired or wireless manner.

The communication interface 11 includes a communication module for connection to the network 50. The communication module is, for example, a communication module compatible with a mobile communication standard such as 4G (4th Generation) or 5G (5th Generation). The communication module may be a communication module that supports standards such as wired LAN or wireless LAN, for example. The communication module may be a communication module that supports short-range wireless communication standards such as Wi-Fi®, Bluetooth® (Wi-Fi and Bluetooth are each a registered trademark in Japan, other countries, or both), or infrared communication. In the present embodiment, the server 10 is connected to the network 50 via the communication interface 11. This enables the server 10 to communicate with the imaging device 20, the measurement device 30, the terminal device 40, other computers, and the like.

The output interface 12 includes one or more output devices. The output devices are, for example, a display, a speaker, or a lamp. The output interface 12 thereby outputs images, sound, light, or the like.

The input interface 13 includes one or more input devices. The input devices are, for example, a touch panel, a camera, or a microphone. The input interface 13 accepts input operations by a user of the server 10, for example.

The memory 14 is, for example, a semiconductor memory, a magnetic memory, or an optical memory. The memory 14 functions as, for example, a main memory, an auxiliary memory, or a cache memory. The memory 14 stores any information used in the operation of the server 10. For example, the memory 14 stores system programs, application programs, embedded software, or databases. The information stored in the memory 14 may be updateable with information acquired from the network 50 via the communication interface 11, for example.

For example, the memory 14 may store tire identification information for one or more tires 2 that are subject to degree of wear monitoring. The tire identification information for the tire 2 is information that uniquely identifies the tire 2. The tire identification information is, for example, an identifier (ID) of the tire 2 uniquely issued by the server 10 but may also, for example, be a serial number of the tire 2, a vehicle number of the vehicle 3 on which the tire 2 is mounted, or the like. Furthermore, the memory 14 may store information regarding the tire 2 in association with the tire identification information for the tire 2.

The information regarding the tire 2 may, for example, include at least one of wear information for the tire 2, measurement data regarding the tire 2, configuration information for the tire 2, information on the vehicle 3 on which the tire 2 is mounted, and information on a position at which the tire 2 is mounted in the vehicle 3. The wear information for the tire 2 may, for example, be time series data including the degree of wear of the tire 2 measured in the past, the registration date and time, and the like. The configuration information for the tire 2 includes, for example, the type, model number, material properties, belt angle, tread pattern, size, weight, and the like of the tire 2. The information on the vehicle 3 on which the tire 2 is mounted includes the identification information, type, model number, displacement, number of tires mounted, number of shafts, and the like of the vehicle 3.

The controller 15 includes one or more processors. The processor may, for example, be a general-purpose processor such as a central processing unit (CPU), or a dedicated processor specialized for particular processes. The controller 15 is not limited to a processor and may include one or more dedicated circuits. The dedicated circuit may, for example, be a field-programmable gate array (FPGA) or an application specific integrated circuit (ASIC). The controller 15 controls the respective components to realize the functions of the server 10, including the functions of components such as the communication interface 11, output interface 12, input interface 13, and memory 14 described above.

### (Operations of Tire Wear Monitoring System)

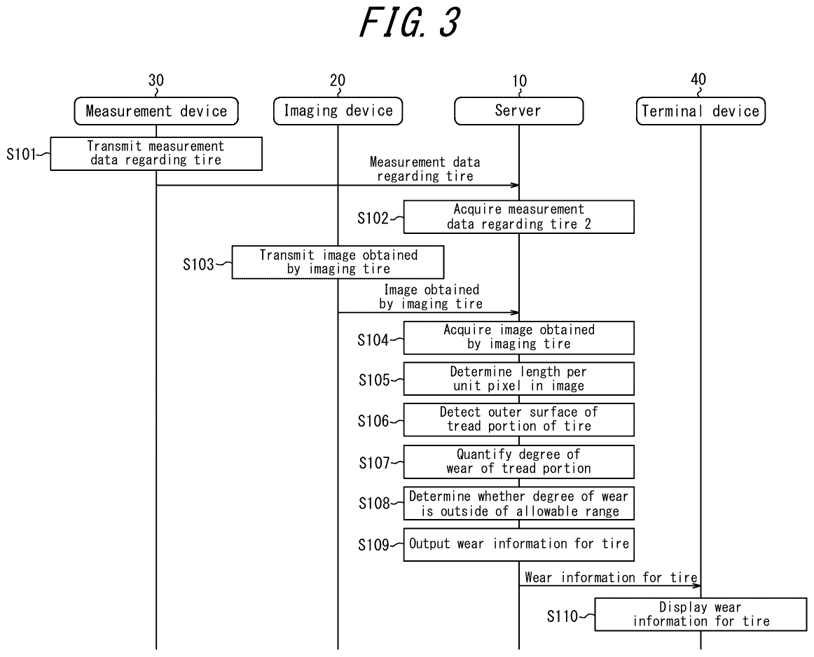

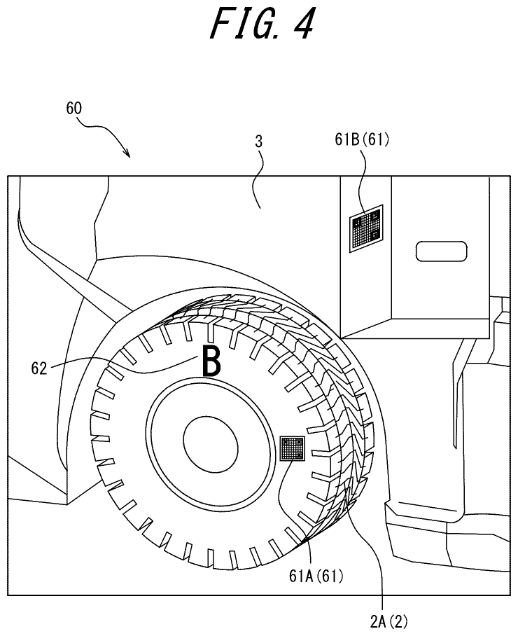

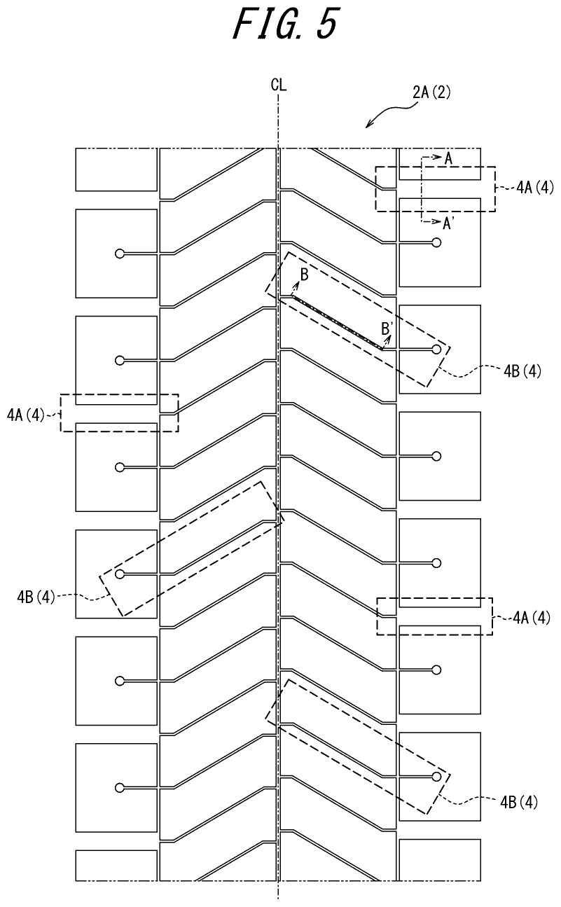

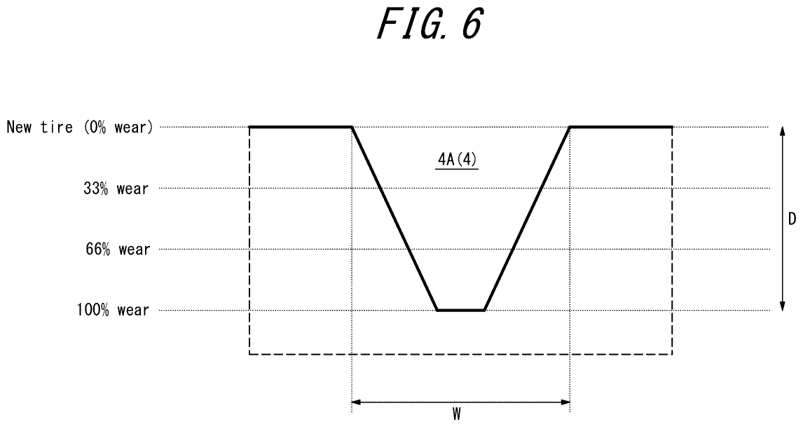

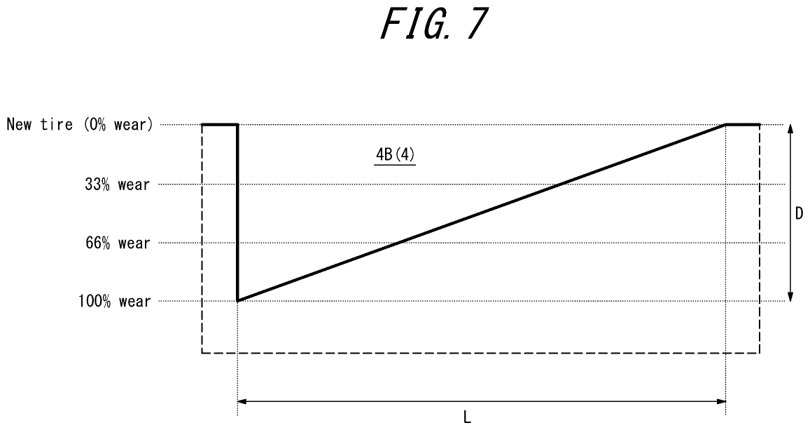

FIGS. 3, 4, 5, 6, and 7 illustrate operations of the tire wear monitoring system 1. FIG. 3 is a flowchart illustrating operations of the tire wear monitoring system 1. FIG. 4 is a diagram illustrating an example of an image 60 obtained by imaging the tire 2. FIG. 5 is a diagram illustrating an example of the outer surface of the tread portion 2A of the tire 2. FIG. 6 is a cross-sectional view illustrating a cross-section along line A-A′ in FIG. 5. FIG. 7 is a cross-sectional view illustrating a cross-section along line B-B′ in FIG. 5.

The flowchart illustrated in FIG. 3 illustrates operations of the server 10, the imaging device 20, the measurement device 30, and the terminal device 40 included in the tire wear monitoring system 1. Therefore, the description of these operation corresponds to a tire wear monitoring method executed by the tire wear monitoring system 1, as well as to a tire wear monitoring method executed by each of the server 10, the imaging device 20, the measurement device 30, and the terminal device 40, all of which are included in the tire wear monitoring system 1.

In describing these operations, it is assumed that the controller 15 of the server 10 has the tire identification information for the tire 2, and the information regarding the tire 2 associated with the tire identification information for the tire 2, stored in the memory 14.

As an example, operations by which the server 10 monitors the degree of wear of the tread portion 2A of the tire 2 based on the image 60 illustrated in FIG. 4 are described in the present operation example. In such a case, the imaging device 20 may be installed at a position where the tread portion 2A of the tire 2 can be imaged. In the present embodiment, the imaging device 20 is described as being installed on the travel route of the vehicle 3 at a position such that the tread portion 2A of the tire 2 can be imaged from diagonally in front. However, the imaging device 20 may be installed at a position such that the front or rear of the vehicle 3 can be imaged or may be installed on the road surface of the travel route along which the vehicle 3 travels.

Referring to FIG. 3, in step S101, the measurement device 30 transmits to the server 10 the measurement data regarding the tire 2, as measured using the sensor.

Specifically, the measurement device 30 uses sensors to measure measurement data regarding the tire 2. The measurement device 30 may transmit the measurement data regarding the tire 2 to the server 10 each time the measurement data regarding the tire 2 is measured or transmit the measurement data regarding the tire 2 measured over a predetermined period of time to the server 10 collectively. In the present operation example, the measurement device 30 includes a digital tachograph and TPMS. Therefore, the measurement data regarding the tire 2 includes tire condition data on the tire 2, such as the internal pressure (air pressure), inner cavity temperature, and thermal history of the tire 2, and travel data on the vehicle 3, such as the travel time and travel distance of the vehicle 3. However, the measurement data transmitted from the measurement device 30 may include data other than the data described above.

In step S102, the controller 15 of the server 10 acquires measurement data regarding the tire 2.

Specifically, the controller 15 of the server 10 receives the measurement data regarding the tire 2 from the measurement device 30 via the communication interface 11. However, the controller 15 may also receive the measurement data regarding the tire 2 measured by the measurement device 30 via a computer other than the measurement device 30. The controller 15 may store the received measurement data regarding the tire 2 in the memory 14 in association with the identification information for the tire 2.

In step S103, the imaging device 20 transmits the image 60, obtained by the camera imaging the tire 2, to the server 10.

Specifically, the imaging device 20 uses the camera to image the tire 2 and generates the image 60 of the tire 2. The image 60 is preferably a plurality of still or moving images captured continuously. The image 60 may, however, be a single still image. The image 60 is, for example, a photograph captured with a visible light camera. However, the image 60 may be any image, such as a thermographic image captured with a thermographic camera. At least a part of the vehicle 3 on which the tire 2 is mounted may also appear in the captured image 60 of the tire 2 in addition to at least a part of the tire 2. As an example of a photograph, the image 60 illustrated in FIG. 4 is assumed to be transmitted from the imaging device 20 to the server 10 in the present operation example. The tire 2 and a portion of the vehicle 3 on which the tire 2 is mounted appear in the image 60.

Referring again to FIG. 3, in step S104, the controller 15 of the server 10 acquires the image 60 obtained by imaging the tire 2.

Specifically, the controller 15 of the server 10 receives the image 60 obtained by imaging the tire 2 from the imaging device 20 via the communication interface 11. However, the controller 15 may also receive the image 60 captured by the imaging device 20 via a computer other than the imaging device 20. The controller 15 may store the received image 60 in the memory 14 in association with the identification information for the tire 2.

In step S104, the controller 15 of the server 10 may furthermore identify the identification information for the tire displayed on the tire 2 or on the vehicle 3 on which the tire 2 is mounted as appearing in the image 60. This enables the controller 15 to identify the tire 2 from the image 60 even if the tire 2 appearing in the image 60 has not been identified in advance. Specifically, by image processing, the controller 15 identifies a display portion 61 indicating the identification information for the tire 2 in the image 60. As illustrated in FIG. 4, the display portion 61 may, for example, be a two-dimensional code such as a Quick Response (QR) Code® (QR code is a registered trademark in Japan, other countries, or both) or an Augmented Reality (AR) marker. In such a case, the controller 15 can read the identification information for the tire 2 from the display portion 61, which is a two-dimensional code. The display portion 61 is not, however, limited to a two-dimensional code and may be any display, such as a character string, symbol, graphic, color, pattern, or one-dimensional code.

The display portion 61, which indicates the identification information for the tire 2, may be displayed at any position. For example, in FIG. 4, display portions 61A and 61B are illustrated. The display portion 61A is provided on the side portion of the tire 2. In such a case, even if the tire 2 is mounted on another vehicle 3 as a result of tire rotation or the like, the identification information for the tire 2 can be identified based on the same display portion 61. The display portion 61B is provided on the vehicle body of the vehicle 3 on which the tire 2 is mounted. In such a case, since the display portion 61 is provided on the vehicle body of the vehicle 3, the visibility of the display portion 61 is less likely to deteriorate even if the outer surface of the tire 2 is soiled by mud or is scratched.

Referring again to FIG. 3, in step S105, the controller 15 of the server 10 determines the actual length per unit pixel in the image 60.

Any method can be employed to determine the actual length per unit pixel. For example, the controller 15 of the server 10 may store the actual length per unit pixel in the image 60 in the memory 14 in order to calculate the actual length of the object as appearing in the image 60.

Alternatively, the controller 15 of the server 10 may store, in the memory 14, a reference member 62 associated with the tire 2 to be used in the determination. The reference member 62 associated with the tire 2 may be a groove, letter, symbol, graphic, color, or pattern on the outer surface of the tire 2. In the example illustrated in FIG. 4, the reference member 62 is a letter provided on the outer surface of the side portion of the tire 2. The controller 15 may determine the actual length per unit pixel in the image 60 based on the actual length of the reference member 62 associated with the tire 2 and the length of the reference member 62 as appearing in the image 60.

For example, the controller 15 of the server 10 identifies the outline of the reference member 62 appearing in the image 60. The controller 15 identifies the distance between the two most distant points of the identified outline of the reference member 62 as the length of the reference member 62 as appearing in the image 60. The length of the reference member 62 as appearing in the image 60 may be expressed as a number of pixels. The controller 15 can determine the actual length per unit pixel in the image 60 from the number of pixels corresponding to the length of the reference member 62 as appearing in the image 60 and the actual length of the reference member 62 associated with the tire 2. This can improve the accuracy of estimating the depth of the groove in the tread portion 2A of the tire 2 in subsequent processing. The reference member 62 may, however, be the rim of the tire 2. In such a case, the length of the reference member 62 may, for example, be the rim diameter of the tire 2.

Referring again to FIG. 3, in step S106, the controller 15 of the server 10 detects the outer surface of the tread portion 2A of the tire 2 appearing in the image 60.

Any method can be employed to detect the outer surface of the tread portion 2A. For example, the controller 15 of the server 10 may store, in the memory 14 in advance, an image analysis algorithm for identifying the outer surface of the tread portion 2A of the tire 2 appearing in the image 60.

In the present embodiment, the image analysis algorithm may be constructed by statistical methods such as machine learning or deep learning. For example, the image analysis algorithm may be constructed by a statistical method using, as teacher data, the image 60 obtained by imaging the tire 2 and the outer surface of the tread portion 2A of the tire 2 as identified by a human. As a result, the detection accuracy of the outer surface of the tread portion 2A can be improved by accumulation of teacher data. The image analysis algorithm may, however, include a predetermined arithmetic process not based on a statistical method.

The controller 15 of the server 10 may store the detected outer surface of the tread portion 2A of the tire 2 in the memory 14 as wear information for the tire 2 in association with the identification information for the tire 2, as illustrated in FIG. 5. In a case in which the image 60 is not an image obtained by imaging the outer surface of the tread portion 2A from the front, the controller 15 may perform a correction such as trapezoidal correction so that the detected outer surface of the tread portion 2A of the tire 2 is viewed from the front. This can improve the accuracy of estimating the depth of the groove in the tread portion 2A of the tire 2 in subsequent processing.

Referring again to FIG. 3, in step S107, the controller 15 of the server quantifies the degree of wear of the tread portion 2A of the tire 2 appearing in the image 60.

Any method can be employed to quantify the degree of wear. The controller 15 of the server 10 may use the depth D of a predetermined groove 10 4 in the tread portion 2A as an index in quantifying the degree of wear. The controller 15 of the server 10 may estimate the depth D of the predetermined groove 4 from at least one of the width W or the length L of the predetermined groove 4 in the tread portion 2A of the tire 2 appearing in the image 60. For this purpose, the controller 15 may store, in the memory 14 in advance, a correspondence algorithm for estimating the depth D of the predetermined groove 4 from at least one of the width W and the length L of the predetermined groove 4 of the tire 2. The controller 15 identifies the predetermined groove 4 from the outer surface of the tread portion 2A detected in step S106. For example, the controller 15 may store the tread pattern of the tire 2 and the position of the predetermined groove 4 in the tread pattern in correspondence in the memory 14 in order to identify the predetermined groove 4.

The controller 15 of the server 10 then calculates the width W and the length L of the identified predetermined groove 4. The controller 15 may use the actual length per unit pixel in the image 60 as calculated in step S105 when calculating the width W and the length L of the predetermined groove 4. The controller 15 then estimates the depth D of the predetermined groove 4 from at least one of the width W and the length L of the predetermined groove 4 using a correspondence algorithm. The depth D of the predetermined groove 4 is, for example, the distance from the outer surface of the tire 2 to the deepest portion of the predetermined groove 4. The controller 15 may store the ratio of the estimated depth D of the predetermined groove 4 to the initial value of the depth of the predetermined groove 4 as the degree of wear of the tread portion 2A of the tire 2 in association with the identification information for the tire 2 in the memory 14. In the case of more than one predetermined groove 4, the shallowest among the depths D of the predetermined grooves 4 (the depth D representing the greatest wear) may be taken as the depth D of the predetermined groove 4 of the tire 2 in subsequent processing.

With reference to FIGS. 5, 6, and 7, a specific example of a method of estimating the depth D of the predetermined groove 4 from at least one of the width W and the length L of the predetermined groove 4 is illustrated below. In the example illustrated in FIG. 5, two types of grooves 4A and 4B are provided as the predetermined grooves 4 in the tread portion 2A of the tire 2. The predetermined grooves 4A and 4B are provided at predetermined intervals in the circumferential direction of the tire 2. Furthermore, the predetermined grooves 4A and 4B are provided on both sides of the tread portion 2A in the tire width direction with the equatorial plane CL of the tire 2 as a boundary therebetween. However, the type, number, and position of the predetermined grooves 4 provided in the tread portion 2A may be determined freely. In the following description, the predetermined grooves 4A and 4B are collectively referred to simply as the predetermined groove 4 when no distinction therebetween is made.

As a first example, a groove 4A having a width W that varies stepwise according to the groove depth D may be used for estimation as the predetermined groove 4 of the tire 2. The width W of the predetermined groove 4A is configured to be correlated with the depth D of the predetermined groove 4A. Specifically, as illustrated in FIG. 6, the predetermined groove 4A is configured so that the left and right groove walls are inclined in a cross-section perpendicular to the length direction (extending direction) of the predetermined groove 4A, and the width W increases from the groove bottom towards the outer surface of the tread portion 2A. Therefore, as wear progresses from a new tire (0% wear) to 33% wear and 66% wear, the depth D of the predetermined groove 4A becomes shallower, and consequently the width W of the predetermined groove 4A exposed on the outer surface of the tread portion 2A becomes narrower. As a correspondence algorithm, the controller 15 of the server 10 can thereby estimate the depth D from the width W of the predetermined groove 4A using correspondence information between the depth D and the width W of the predetermined groove 4A.

As a second example, a groove 4B having a depth D that varies stepwise along the length direction of the groove may be used for estimation as the predetermined groove 4 of the tire 2. The position in the length direction of the predetermined groove 4B is configured to be correlated with the depth D of the predetermined groove 4B. Specifically, as illustrated in FIG. 7, the predetermined groove 4B has a predetermined inclination at the groove bottom along the length direction of the groove. In other words, the predetermined groove 4B is configured so that the depth D becomes shallower from one end towards the other end in the length direction. Therefore, as wear progresses from a new tire (0% wear) to 33% wear and 66% wear, the depth D of the predetermined groove 4B becomes shallower, and consequently the length L of the predetermined groove 4B exposed on the outer surface of the tread portion 2A becomes shorter. As a correspondence algorithm, the controller 15 of the server 10 can thereby estimate the depth D from the length L of the predetermined groove 4B using correspondence information between the depth D and the length L of the predetermined groove 4B.

In the present embodiment, the correspondence algorithm may be constructed by statistical methods such as machine learning or deep learning. For example, the correspondence algorithm may be constructed by a statistical method using, as teacher data, at least one of the width W and the length L of the predetermined groove 4 of the tire 2 and the depth D of the predetermined groove 4 as measured by a human. As a result, the accuracy of estimating the depth D of the predetermined groove 4 of the tire 2 can be improved by accumulation of teacher data. The correspondence algorithm may, however, include a predetermined arithmetic process not based on a statistical method.

In quantifying the degree of wear, the controller 15 of the server 10 may use, in addition to or instead of the depth D of the predetermined groove 4 in the tread portion 2A, the bias in the degree of wear of the tread portion 2A on both sides of the equatorial plane CL in the tire width direction as an index. Specifically, as a quantification of the degree of wear, the controller 15 may calculate the difference between the depth D of a first groove 4 provided on one side (for example, on the left side of the equatorial plane CL in FIG. 5) and the depth D of a second groove 4 provided on the other side (on the right side of the equatorial plane CL) of the tread portion in the tire width direction, with the equatorial plane CL of the tire 2 as the boundary therebetween. In this way, the controller 15 can determine the degree of uneven wear in the tire 2 by calculating the difference between the depth D of the first groove 4 and the depth D of the second groove 4.

Referring again to FIG. 3, in step S108, the controller 15 of the server 10 determines whether the degree of wear of the tire 2 is outside of the allowable range of durability of the tire 2.

The allowable range of durability of the tire 2 may be defined freely. For example, the allowable range of durability of the tire 2 may be defined according to the depth D of the predetermined groove 4, described above as the degree of wear of the tire 2. For example, the controller 15 of the server 10 may determine that the degree of wear of the tire 2 is outside of the allowable range of durability of the tire 2 in a case in which the depth D of the predetermined groove 4 is shallower than the value determined as the allowable range of durability of the tire 2.

Furthermore, the allowable range of durability of the tire 2 may be determined in a composite manner using other factors in addition to the degree of wear of the tire 2. The other factors are, for example, information included in the measurement data regarding the tire 2 acquired from the measurement device 30. As an example, the controller 15 of the server 10 may determine whether the degree of wear is outside of the allowable range of durability of the tire 2 based on the degree of wear of the tire 2 and the travel distance or travel time of the vehicle 3 on which the tire 2 is mounted. Specifically, in a case in which the travel distance or travel time of the vehicle 3 is long, it is considered that the tire 2 has already deteriorated and that wear of the tire 2 progresses quickly. Therefore, the allowable range may be set so that the greater the degree of wear of the tire 2 and the greater the travel distance or travel time of the vehicle 3 on which the tire 2 is mounted, the more likely the degree of wear will exceed the allowable range. This can improve the accuracy of determining whether the degree of wear of the tire 2 exceeds the allowable range of durability of the tire 2.

As another example, the controller 15 of the server 10 may determine whether the degree of wear is outside of the allowable range of durability of the tire 2 based on the degree of wear of the tire 2 and the thermal history of the tire 2. Specifically, in a case in which the thermal history of the tire 2 is large, it is considered that the tire 2 has already deteriorated and that wear of the tire 2 progresses quickly. Therefore, the allowable range may be set so that the greater the degree of wear of the tire 2 and the greater the thermal history of the tire 2, the more likely the degree of wear will exceed the allowable range. This can improve the accuracy of determining whether the degree of wear of the tire 2 exceeds the allowable range of durability of the tire 2.

The allowable range of durability of the tire 2 may be set at a plurality of levels. For example, the allowable range of durability of the tire 2 may be associated with at least one of replacement, retreading, and rotation of the tire 2. For example, in a case in which the allowable range is associated with the timing of two rotations, the controller 15 may determine that the degree of wear is outside of the allowable range in the case of the degree of wear exceeding 33% and the case of exceeding 66%.

In step S109, the controller 15 of the server 10 outputs the wear information for the tire 2 in a case in which the degree of wear of the tire 2 is determined to be outside of the allowable range.

Any method can be employed to output the wear information for the tire 2. For example, the controller 15 of the server 10 may display the wear information for the tire 2 via the output interface 12, such as a display. Alternatively, the controller 15 may transmit to the terminal device 40, via the communication interface 11, a request to display the wear information for the tire 2. In such a case, the terminal device 40 can display the wear information for the tire 2 in step S110 via a display or the like based on the request received from the server 10. The wear information for the tire 2 includes, for example, the degree of wear of the tire 2. However, the wear information for the tire 2 is not limited to the degree of wear of the tire 2 and may include any information, such as the content of the allowable range that the degree of wear is outside of, a warning message, or the like. As a result, the user of the tire wear monitoring system 1 can easily recognize the degree of wear of the tread portion 2A of the tire 2 and make plans for replacement, retreading, rotation, or the like of the tire 2 before the tire 2 fails.

As described above, in the present embodiment, the server 10, i.e., the tire wear monitoring device, acquires an image 60 obtained by imaging the tread portion 2A of the tire 2. The server 10 then quantifies the degree of wear of the tread 2A appearing in the image 60. The server 10 determines whether the degree of wear is outside of an allowable range of durability of the tire 2 and outputs wear information for the tire 2 in a case in which the degree of wear is determined to be outside of the allowable range.

According to this configuration, the server 10 can automatically monitor the degree of wear of the tread 2A of the tire 2 based on the acquired image 60 and output wear information for the tire 2 according to the degree of wear. This can suppress a decrease in productivity due to sudden failure of the tire 2 at the mine site and an increase in the burden on workers for inspecting the tire 2. Therefore, according to the present embodiment, the usefulness of technology for monitoring the degree of wear of the tire 2 can be improved.

Although the present disclosure is based on drawings and embodiments, it is to be noted that various changes and modifications could be made by those skilled in the art based on the present disclosure. Therefore, such changes and modifications are to be understood as included within the scope of the present disclosure. For example, the configurations, functions, and the like included in each embodiment may be reordered in any logically consistent way. Furthermore, the configurations, functions, and the like included in each embodiment can be used in combination with other embodiments. A plurality of configurations, functions, or the like can also be combined into one or divided, or a portion thereof can be omitted.

For example, an embodiment in which a general-purpose computer functions as the server 10 according to the above embodiment is also possible. Specifically, a program describing the processing content for realizing each function of the server 10 according to the above embodiment is stored in the memory of the general-purpose computer, and the program is read and executed by the processor. Accordingly, the present disclosure can also be realized as a program executable by a processor or as a non-transitory computer readable medium storing the program. Examples of non-transitory computer readable media include a magnetic recording device, an optical disc, a magneto-optical recording medium, and a semiconductor memory.

### INDUSTRIAL APPLICABILITY

According to the present disclosure, a tire wear monitoring device and a tire wear monitoring method that can improve the usefulness of technology for monitoring the degree of wear of a tire can be provided.

REFERENCE SIGNS LIST

| | |
|---|---|
| 1 | Tire wear monitoring system |
| 2 | Tire |
| 2A | Tread |
| 3 | Vehicle |
| 4 (4A, 4B) | Groove |
| 10 | Server (tire wear monitoring device) |
| 11 | Communication interface |
| 12 | Output interface |
| 13 | Input interface |
| 14 | Memory |
| 15 | Controller |
| 20 | Imaging device |
| 30 | Measurement device |
| 40 | Terminal device |
| 50 | Network |
| 60 | Image |
| 61 (61A, 61B) | Display portion |
| 62 | Reference member |
| CL | Equatorial plane |
| D | Depth of groove |
| W | Width of groove |
| L | Length of groove |

1. A tire wear monitoring device comprising a controller configured to:
acquire an image obtained by imaging a tread portion of a tire;
quantify a degree of wear of the tread portion appearing in the image;
determine whether the degree of wear is outside of an allowable range of durability of the tire; and
output wear information for the tire in a case in which the degree of wear is determined to be outside of the allowable range.

2. The tire wear monitoring device according to claim 1, wherein quantifying of the degree of wear includes estimating a depth of a predetermined groove in the tread portion from at least one of a width and a length of the predetermined groove appearing in the image.

3. The tire wear monitoring device according to claim 2, wherein
the width of the predetermined groove varies stepwise according to the depth of the predetermined groove, and
the controller is further configured to estimate the depth of the predetermined groove from the width of the predetermined groove using correspondence information between the depth and the width of the predetermined groove.

4. The tire wear monitoring device according to claim 2, wherein
the depth of the predetermined groove varies stepwise along a length direction of the predetermined groove, and
the controller is further configured to estimate the depth of the predetermined groove from the length of the predetermined groove using correspondence information between the depth and the length of the predetermined groove.

5. The tire wear monitoring device according to claim 2, wherein
as the predetermined groove, the tire includes a first groove provided on one side and a second groove provided on another side of the tread portion in a tire width direction, with an equatorial plane of the tire as a boundary therebetween, and
quantifying of the degree of wear includes calculating a difference between a depth of the first groove and a depth of the second groove.

6. The tire wear monitoring device according to claim 1, wherein
the controller is further configured to
acquire a travel distance or a travel time of a vehicle on which the tire is mounted, and
determine whether the degree of wear is outside of the allowable range of durability of the tire based on the degree of wear and on the travel distance or the travel time of the vehicle.

7. The tire wear monitoring device according to claim 1, wherein
the controller is further configured to
acquire a thermal history of the tire, and
determine whether the degree of wear is outside of the allowable range of durability of the tire based on the degree of wear and the thermal history of the tire.

8. A tire wear monitoring method to be executed by one or more computers, the method comprising:
acquiring an image obtained by imaging a tread portion of a tire;
quantifying a degree of wear of the tread portion appearing in the image;
determining whether the degree of wear is outside of an allowable range of durability of the tire; and
outputting wear information for the tire in a case in which the degree of wear is determined to be outside of the allowable range.

9. The tire wear monitoring device according to claim 2, wherein
the controller is further configured to
acquire a travel distance or a travel time of a vehicle on which the tire is mounted, and
determine whether the degree of wear is outside of the allowable range of durability of the tire based on the degree of wear and on the travel distance or the travel time of the vehicle.

10. The tire wear monitoring device according to claim 2, wherein
the controller is further configured to
acquire a thermal history of the tire, and
determine whether the degree of wear is outside of the allowable range of durability of the tire based on the degree of wear and the thermal history of the tire.

11. The tire wear monitoring device according to claim 3, wherein
the controller is further configured to
acquire a travel distance or a travel time of a vehicle on which the tire is mounted, and
determine whether the degree of wear is outside of the allowable range of durability of the tire based on the degree of wear and on the travel distance or the travel time of the vehicle.

12. The tire wear monitoring device according to claim 3, wherein
the controller is further configured to
acquire a thermal history of the tire, and
determine whether the degree of wear is outside of the allowable range of durability of the tire based on the degree of wear and the thermal history of the tire.

13. The tire wear monitoring device according to claim 4, wherein
the controller is further configured to
acquire a travel distance or a travel time of a vehicle on which the tire is mounted, and
determine whether the degree of wear is outside of the allowable range of durability of the tire based on the degree of wear and on the travel distance or the travel time of the vehicle.

14. The tire wear monitoring device according to claim 4, wherein
the controller is further configured to
acquire a thermal history of the tire, and
determine whether the degree of wear is outside of the allowable range of durability of the tire based on the degree of wear and the thermal history of the tire.

15. The tire wear monitoring device according to claim 5, wherein
the controller is further configured to
acquire a travel distance or a travel time of a vehicle on which the tire is mounted, and
determine whether the degree of wear is outside of the allowable range of durability of the tire based on the degree of wear and on the travel distance or the travel time of the vehicle.

16. The tire wear monitoring device according to claim 5, wherein
the controller is further configured to
acquire a thermal history of the tire, and
determine whether the degree of wear is outside of the allowable range of durability of the tire based on the degree of wear and the thermal history of the tire.
